(19) United States
(12) Patent Application Publication
(10) Pub. No.: US 2004/0217882 A1
(43) Pub. Date: Nov. 4, 2004

(54) Manually adjusted electromagnetic inductor for frequency control in inductive detector loops

(76) Inventors: Lewis T. Ross, Antioch, CA (US); Stephen E. Moore, Antioch, CA (US); Joel W. McDaniel, Clayton, CA (US)

Correspondence Address: Lewis T. Ross, 3944 East Larkspur Drive, Antioch, CA, 94531, US

(21) Appl. No.: 10/426,535

(22) Filed: May 1, 2003

(51) Int. Cl. G08G 1/01

(52) U.S. Cl. 340/941

(57) ABSTRACT

A. The apparatus is intended for installation as an appurtenance to traffic signal inductive loop detectors.

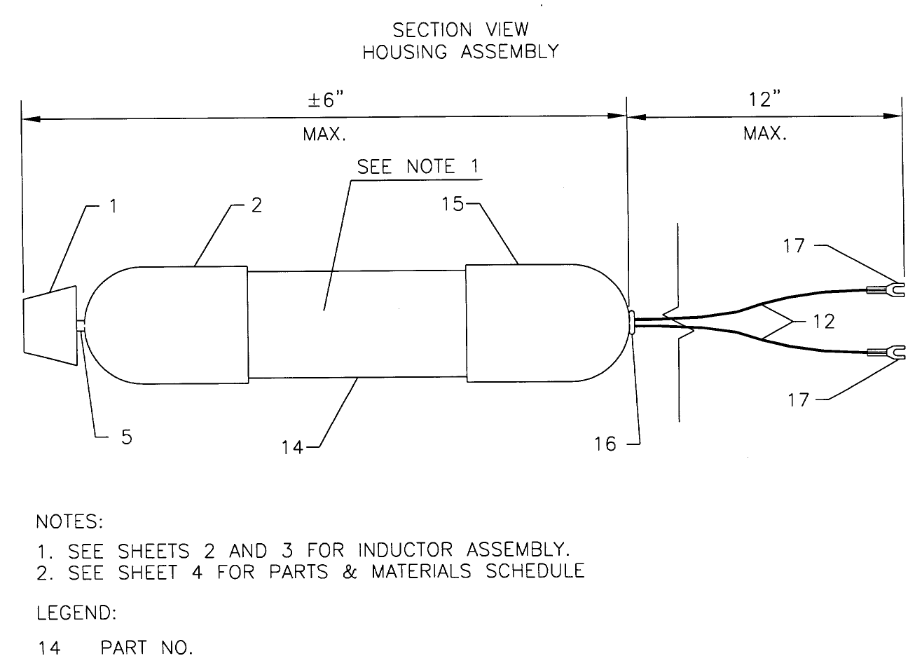

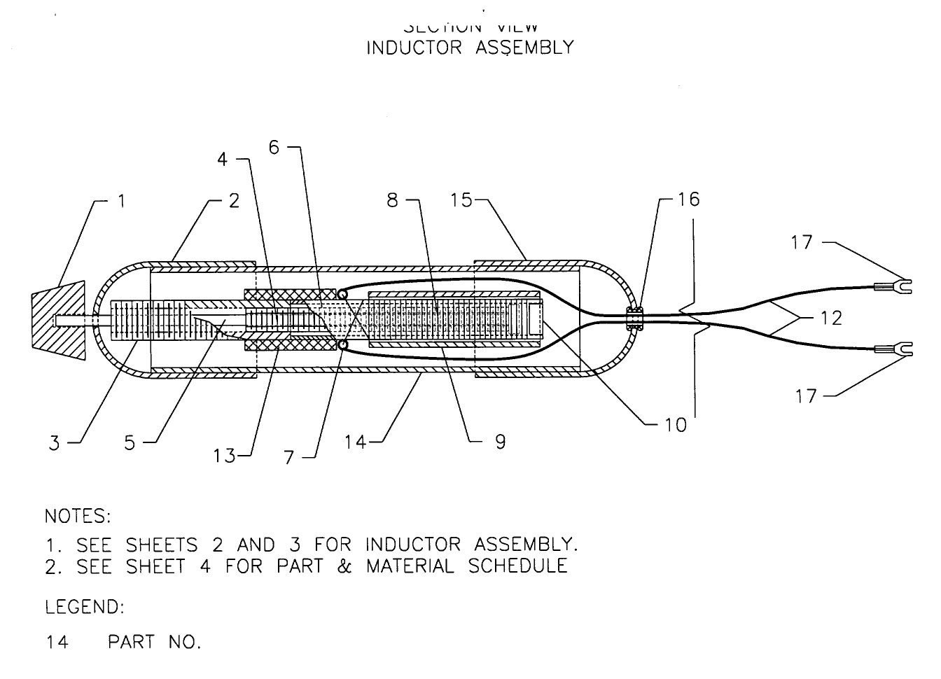

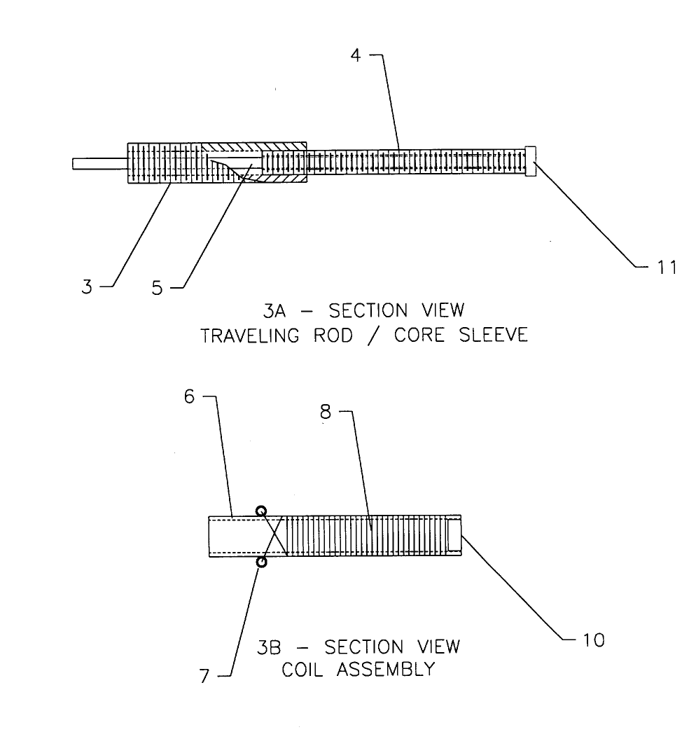

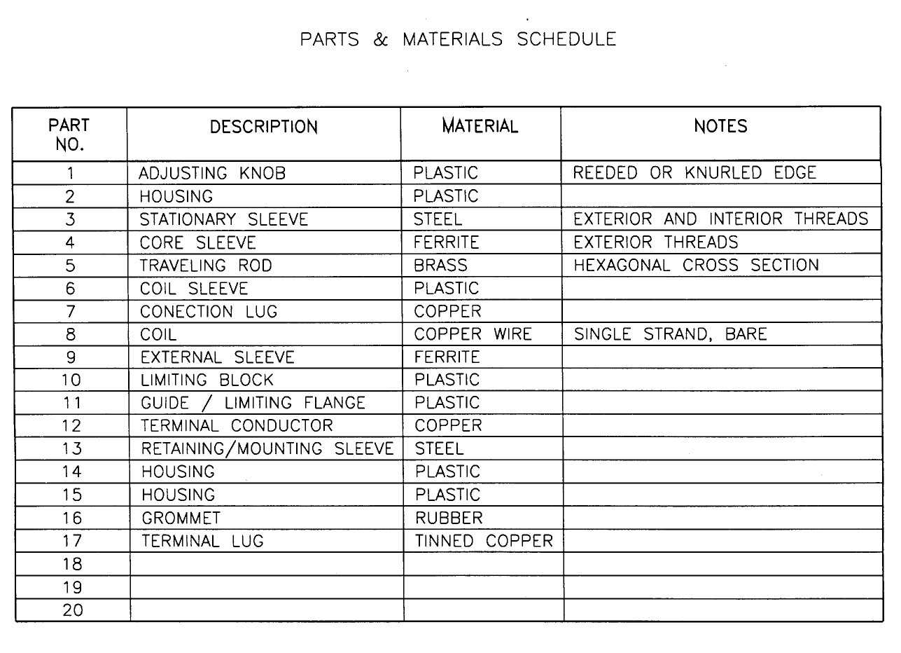

B. The apparatus is a maintenance aid. Installation of the apparatus will reduce the incidence of maintenance where the frequency of the detector loop drifts out of specification due to conditions of installation or environmental factors.

C. The apparatus is manually operated. The apparatus is used to increase the frequency of the detector loop when, the frequency of the detector loop varies out of the specified frequency range for proper operation of the detector loop for sensing the presence of a vehicle.

D. The apparatus functions by means of a traveling rod and ferrite sleeve positioned by linear movement parallel to the center axis of a coil. A knob connected to the traveling rod, is used to change the position of the traveling rod by manually rotating the knob.

### SECTION 5—BACKGROUND OF INVENTION

4.1 The inductive loop detector is a common installation on highways, local streets and roadways used to sense on vehicle presence. Loop detectors have been widely used for more than 20 years and are integral parts of traffic signals.

An inductive detector consists of a wire coil (loop), made of twisted, insulated wire embedded in the paved surface of a roadway. Loops may take a variety of shapes and sizes. Each shape has somewhat different electromagnetic properties. The loop is connected to an electronic detector unit by means of a lead-in cable and other appurtenant hardware.

The detector amplifier (unit) provides the power that activates the loops as well as allows tuning of the loop to sense the presence of vehicles. The detector unit integrates circuitry to measure changes in the frequency of the loop and to generate a call signal to the traffic signal controller unit. The call signal is used to actuate the traffic signal controller unit.

A loop is excited by an electrical impulse from a detector unit creating an electromagnetic field. Depending on the loop size, shape and other factors, the loop frequency may range from 200 kilohertz with no vehicle in the detection zone to 10 kilohertz with a vehicle in the detection zone. When a vehicle passes over the loop or stops on top of it, the vehicle's frame and body acts as a conductor, reducing the inductance of the loop. The decreased inductance increases the oscillation frequency in the loop and sends a pulse through the lead-in wires and cable to the detector unit. In most conventional installations, the inductance or frequency change must cross some pre-set threshold before the detector unit will interpret the changes as a vehicle.

The design and installation of the loop including wire size; number of turns; lead-in length; and insulation as well as a variety of environmental factors contribute to frequency of a loop.

The fluctuation of the inductance or frequency of the loop varies outside of the pre-set range of the detector unit is sometimes referred to as drift. When drift occurs, the detection system may fail to detect the presence of a vehicle or the detector unit may generate a false call signal. Such detector failures necessitate detector maintenance. Installation of the apparatus will correct the frequency drift and the detector will function properly.

### SECTION 6—SUMMARY OF INVENTION

5.1 The invention is a “Manually Adjusted Electromagnetic Inductor for Frequency Control in Inductive Detector Loops” for installation as an appurtenance to a traffic signal inductive loop detector. The frequency control unit is used to increase the frequency of the detector loop when, the frequency of the detector loop fluctuates outside of the specified frequency range of the detector unit.

### SECTION 7—DESCRIPTION OF DRAWINGS

6.1 Drawings

A. Sheet 1, “Side View—Housing Assembly”:

B. Sheet 2, “Section View—Inductor Assembly”:

C. Sheet 3, “Details—Traveling Rod and Coil”

D. Sheet 4, “Parts and Materials Schedule”

### SECTION 8—DETAILED DESCRIPTION

8.1 General

8.1.1 Codes and Standards

A. National Electric Code

8.1.2 Abbreviations and Definitions

A. AWG—American Wire Gage

B. DLC—Detector Loop Cable

C. NEMA—National Electrical Manufacturers Association

8.1.3 Description and Theory of Operation

A. The invention, hereinafter referred to as “apparatus”, is an electromagnetic inductor used to manually adjust the frequency of a vehicle detector loop. The operation of detector loops for sensing the presence of a vehicle is described in Section 4—“Background of Invention”.

B. The apparatus is intended for installation as an appurtenance to an inductive loop detector.

C. Installation of the apparatus allows the circuit properties of the detector loop to be adjusted by manual means.

D. The apparatus functions by means of a traveling rod and ferrite sleeve positioned by linear movement parallel to the center axis of a coil. A knob connected to the traveling rod, is used to manually change the position of the traveling rod.

E. The apparatus shall have an operating range of 80 KHz to 300 KHz when installed in parallel with the traffic signal detector loop lead-in cable (DLC) at the detector panel in the controller cabinet.

F. The function of the apparatus is governed by an inverse relationship for combining parallel inductors described by the equation:

((L1×L2)/(L1+L2))=L_{Total}

In order to provide any useful adjustment effect at the lower limit of the detector unit, the apparatus must have a larger inductance than the parallel circuit to effect the upward adjustment in frequency.

The apparatus shall have an adjustment range near one order of magnitude larger than the detector loop at the lower limit. This approach will provide the needed level of “fine tuning,” so that loop adjustments can be made.

8.2 Materials

8.2.1 General

A. The apparatus shall be fabricated of all new materials.

B. All materials shall conform to the requirements of the most recent edition of the National Electric Code.

8.2.2 Conductors

A. Terminal Conductors: Terminal conductors shall conform to the following requirements:

1. Terminal conductors shall be soft drawn, twisted, stranded copper of round or substantially circular cross section and insulated.

2. Insulation shall be of a type resistant to flame, heat and wear. The insulation shall be permanently marked with the manufacturers name or trade designation, wire gauge, voltage rating.

3. Size of Conductors: No terminal conductor shall be smaller than No. 16 AWG.

B. Coil Conductor: Conductor used in the fabrication of coils shall conform to the following requirements:

1. Conductor shall be a continuous, single strand of bare, soft drawn solid copper of round or substantially circular cross.

2. Size of Conductor: Conductor shall be No. 30.

8.2.3 Terminal Lugs

A. Terminal connections may be made by means of either soldered or solderless (crimp type) connectors fabricated of tinned copper.

8.2.4 Coil

A. The coil shall be a multi-turn coil wound on a plastic sleeve.

B. The coil sleeve shall be of such inside diameter as to allow the traveling rod and core sleeve assembly to advance into and retreat from the coil sleeve.

8.2.5 Traveling Rod

A. The traveling rod shall be fabricated of extruded brass. The rod shall be of hexagonal cross section. The rod shall be of sufficient cross section and rigidity to resist torsion and bending perpendicular to the longitudinal axis of the rod.

B. The traveling rod shall be fabricated with a guide/limiting flange at one end of the rod. The flange shall guide/limit the linear movement of the rod within the coil sleeve.

8.2.6 Stationary Sleeve

A. The stationary sleeve shall be fabricated of mild steel. The interior and exterior of the sleeve shall be threaded the entire length the barrel. Threads shall be national fine. The sleeve shall be of such inside diameter and thread as to allow the core sleeve to be advance from and retreat within the stationary sleeve.

8.2.7 Core Sleeve

A. The core sleeve shall be fabricated of a magnetic oxide commonly known as ferrite. The exterior of the sleeve shall be threaded the entire length the barrel. Threads shall be national fine. The sleeve shall be of such inside diameter as to slide over the traveling rod.

8.2.8 Adjusting Knob

A. A knob fabricated of a non-conductive, heat resistant, molded plastic.

B. The knob may have a reeded or knurled edge.

C. The knob shall be of a design that allows attachment to the traveling rod by any means that provides a positive axial lock.

8.2.9 External Sleeve

A. The external sleeve shall be fabricated of a magnetic oxide commonly known as ferrite.

B. The sleeve shall be of such inside diameter as to allow the sleeve to be installed over the coil.

8.2.10 Housing

A. The housing shall be fabricated of a non-conductive, flame and heat resistant molded plastic.

B. The housing shall consist of multiple sections for ease of fitting and mounting the inductor assembly in the housing.

C. The housing shall be fabricated with a hole through the housing wall at each end of the housing assembly. The holds shall provided a suitable means for the terminal conductors and the traveling rod to pass through the housing wall.

8.2.11 Grommet

A. A grommet fabricated of natural or synthetic rubber of suitable design for installation in the housing wall to protect terminal conductors installed through the housing wall from excessive wear.

8.2.12 Restraining/Mounting Sleeve

A. The restraining/mounting sleeve shall be fabricated of mild steel. The sleeve shall be of such inside diameter as to fit over the stationary sleeve and coil sleeve.

B. The restraining/mounting sleeve shall provide a means of rigidly joining the stationary sleeve and coil sleeve.

C. The restraining/mounting sleeve shall provide a means of securing the entire inductor assembly to the housing.

8.2.13 Limiting Block

A. The limiting block shall be installed in the end of the coil sleeve. The method of attachment may be by any means that provides a positive axial lock.

B. The block shall limit the axial movement of the traveling rod/core sleeve assembly to prevent the threaded core sleeve from advancing to far and separating from the stationary sleeve.

8.3 Execution

8.3.1 Coil Fabrication

A. The core of the coil shall be a plastic sleeve.

B. The coil shall be fabricated by winding a continuous, single strand of bare, soft drawn solid copper conductor of round or substantially circular cross section around the exterior or the core rod.

C. Beginning at one end of the core sleeve, the conductor shall be wound around the exterior or the core rod. A length of conductor shall be provided at the beginning and end of the coil for termination at connection posts. The coil shall cover one-half of the overall length of the iron core rod. The first one-quarter of the coil shall be double wound.

D. Connection posts shall be positioned on the exterior of the core sleeve 180° apart and proximate to the end of the coil. The ends of the coil conductor shall be soldered to the connection post.

8.3.2 Control Assembly

A. The control assembly shall consist of the traveling rod, core sleeve and stationary sleeve.

B. The traveling rod shall be fabricated of extruded brass. The rod shall be fabricated with an integral guide/limiting flange at one end. Any portion of the rod that will extend outside of the housing after final assembly or when the rod is fully retracted shall require insulation.

C. Assemble the core sleeve to the traveling rod. Slide the core sleeve over the traveling rod such that the sleeve is seated against the guide/limiting flange.

D. Attach the core sleeve to the rod by any means that provides a positive axial and angular lock with the traveling rod.

E. The completed rod and core sleeve assembly is then fitted to the stationary sleeve. Advance the threaded core sleeve into the stationary sleeve a distance of 1½ times the diameter of the core sleeve.

8.3.3 Inductor Assembly

A. The end of the control assembly with the core sleeve is inserted into the coil sleeve until the guide/limiting flange is seated against the limiting block.

B. Attach the coil sleeve and control assembly with the restraining/mounting sleeve. The ends of the stationary sleeve and coil sleeve shall butt together.

8.3.4 Housing

A. The inductor assembly shall be fitted and mounted in the housing.

B. A hole shall be provided in the housing for the terminal conductors to pass through the housing wall. A grommet made of natural or synthetic rubber shall be fitted in the hole to protect the terminal conductors from wear or damage. The terminal conductors shall be installed through the housing wall.

C. A hole shall be provided in the housing for the end of the traveling rod to protrude through the housing wall.

D. The sections of the housing shall be securely assembled.

8.3.5 Final Assembly

A. After the inductor assembly has been fitted and mounted in the housing and the housing securely sealed:

1. The non-conductive, heat resistant knob shall be attached to end of the traveling rod that protrudes through the housing. The knob shall be attached to the traveling rod by any means that provides a positive axial lock.

2. A terminal connector shall be attached to the end of each of the terminal conductors. The connectors may be soldered or crimped to the conductors.

8.3.6 Factory Testing

A. Connect the apparatus as follows:

1. Connect the apparatus in parallel to a loop or loop simulator and a detector unit.

2. Connect an indicator light to the output circuit of the detector.

3. Apply input power to the detector.

4. Set the detector unit per the manufacturers instructions.

5. Verify that the indicator light is off.

6. Simulate a vehicle a verify that the indicator light is on.

7. Check for all detector unit sensitivity levels and modes.

8.3.7 Customer Installation

A. Installation of the apparatus is by the customer.

B. Wire the apparatus unit in parallel with the detector loop cable and the detector unit in the signal controller cabinet.

C. Verify that the detector unit is properly installed. Apply power and set the sensitivity and mode on the detector unit in accordance with the manufacturers instructions.

D. To adjust loop frequency, slowly turn the adjusting knob on the apparatus. When indicator light on detector unit indicates detection with a vehicle in the detection zone, the apparatus is properly adjusted.

1. 9.1 Applications and Uses
A. An apparatus for installation as an appurtenance to a traffic signal inductive loop detector. The apparatus is used to increase the frequency of the detector loop when, the frequency of the detector loop varies out of the specified frequency range for proper operation of the detector loop for sensing the presence of a vehicle.
B. In reference to the claim in Part 8.1 A. herein, inductive loop detectors have applications other than actuated traffic signal control as described herein. Such applications include but are not limited to vehicle-counting, measurement of vehicle speed, measurement of vehicle length, actuation of gates, cross arms and signs, and detecting vehicle queuing. The apparatus may be utilized as an appurtenance to any application of an inductive loop detector used detect, distinguish, actuate, activate or measure.
9.2 Materials Specifications, Dimensions, Fabrication and Assembly, and Operational Characteristics
A. In reference to the claim in Part 8.1 A. herein above, the materials specifications, dimensions and methods of fabrication and assembly, and operational characteristics described constitute one method of producing a functional apparatus. It is possible to fabricate and assemble a functional apparatus utilizing other materials, dimensions and method of assembly.
